(19) United States
(12) Patent Application Publication
(10) Pub. No.: US 2026/0350980 A1
(43) Pub. Date: Nov. 5, 2026

(54) TWO-STAGE NETWORKS-BASED MULTI-TASK DETECTION METHOD AND SYSTEM

(71) Applicants: Hyundai Motor Company, Seoul (KR); Kia Corporation, Seoul (KR)

(72) Inventors: Jun Zhou, Yantai (CN); Yao Yao, Yantai (CN); Yujun Wang, Yantai (CN)

(21) Appl. No.: 19/400,599

(22) Filed: Nov. 25, 2025

(30) Foreign Application Priority Data
Apr. 30, 2025 (CN) 202510570678.1

(51) Int. Cl. G06V 10/96; G06V 10/44; G06V 10/77; G06V 10/82; G06V 20/59; G06V 40/16; G06V 40/18

(52) U.S. Cl. CPC G06V 10/96; G06V 10/44; G06V 10/7715; G06V 10/82; G06V 20/597; G06V 40/171; G06V 40/18

(57) ABSTRACT

A method and system of multi-task detection are performed based on two-stage networks. The method includes receiving an input image, processing the input image through a first backbone network to produce a first feature map of the input image, and determining a face region from the input image by detecting a face in the input image, extracting a second feature map corresponding to the face region from the first feature map, and inputting the second feature map to a second backbone network for a follow-up multi-task parallel detection. The method and system may be incorporated into a vehicle.

### CROSS-REFERENCE TO RELATED APPLICATION(S)

The present application claims under 35 U.S.C. § 119 (a) the benefit of Chinese Patent Application No. 202510570678.1, filed on Apr. 30, 2025, the entire contents of which are incorporated by reference herein.

### BACKGROUND

### (a) Technical Field

The present disclosure relates to method and system of multi-task detection based on two-stage networks.

### (b) Description of the Related Art

In vehicle production, there is a continuously increasing demand for intelligence and safety of vehicles. Accordingly, vehicles may be equipped with a driver monitoring system (DMS). For example, recently it has been difficult for active safety systems with no DMS mounted therein to get a five-star rating from a governmental agency such as European New Car Assessment Program (E-NCAP). According to the General Safety Regulation (GSR) announced by the European Union, all new cars released in the European market need to include a driver fatigue monitoring system.

Such a driver monitoring system frequently needs to perform computing such as face detection, face key point detection, head posture estimation, and gaze estimation. However, in systems of the related art, each module that performs such computing typically is serial and independent, and thus various pre-processing works needed to be performed on data. As a result, the process required a long time to be performed and it was difficult for the process to satisfy requirements for low latency and high-speed smart cabin.

Meanwhile, since current multi-task networks are one-stage networks with small parallel tasks and low accuracy, it is impossible to optimize a design of an algorithm to adapt to a specific business scenario.

The above description merely provides background information related to present examples, and may include information not constituting prior art.

### SUMMARY

The present disclosure provides a method and system that can achieve substantially constant accuracy and significantly reduce operation time by extracting image features by reusing a common network, and realizing a multi-task detection by using a lightweight branch network.

Aspects of the present disclosure are not limited to the above description, and other aspects not mentioned here will be clearly understood by those skilled in the art from the description below.

According to the present disclosure, a multi-task detection method includes: providing a processor and a memory; receiving, by the processor, an input image; processing, by the processor, the input image through a first backbone network to produce a first feature map of the input image, and determining, by the controller, a face region from the input image by detecting a face in the input image; extracting, by the processor, a second feature map corresponding to the face region from the first feature map; and inputting, by the processor, the second feature map to a second backbone network for a follow-up multi-task parallel detection.

According to an aspect of the present disclosure, there is provided a multi-task detection method including receiving an input image, processing the input image through a first backbone network to produce a first feature map of the input image, and determining a face region from the input image by detecting a face in the input image, cutting out a second feature map corresponding to the face region from the first feature map, and inputting the second feature map to a second backbone network for a follow-up multi-task parallel detection.

In some examples, the first feature map may be produced in a last layer of the first backbone network.

In some examples, the processing the input image through the first backbone network to produce a first feature map of the input image may include performing a convolution and sub-sampling computing process on the input image to produce the first feature map.

In some examples, the detecting a face in the input image may include detecting a face having a highest reliability from a plurality of faces in the input image.

In some examples, the cutting out a second feature map may include cutting out a face region corresponding to a face frame from the first feature map using bilinear interpolation.

In some examples, the inputting the second feature map to a second backbone network for a follow-up multi-task parallel detection may include extracting features respectively associated with multiple follow-up detection tasks from the second feature map through the second backbone network to input each of the extracted features to each of multiple branch networks related to the multiple follow-up detection tasks.

In some examples, the method may further includes training the multiple branch networks based on a sum of loss functions of the multiple branch networks.

In some examples, in a case where the multiple branch networks are trained, the first backbone network may be frozen.

In some examples, the multiple follow-up detection tasks may include one or more of key point detection, head posture estimation, or gaze estimation.

In some examples, the first backbone network may be separately trained.

According to the present disclosure, a multi-task detection system includes: a computing device comprising a memory and a processor, the processor configured to: receive an input image, process the input image through a first backbone network to produce a first feature map of the input image, and determining a face region from the input image by detecting a face in the input image; cut out a second feature map corresponding to the face region from the first feature map; and process the second feature map through a second backbone network for a follow-up multi-task parallel detection.

According to another aspect of the present disclosure, there is provided a multi-task detection system including a face detection module configured to receive an input image, process the input image through a first backbone network to produce a first feature map of the input image, and determining a face region from the input image by detecting a face in the input image, a face feature extraction module configured to cut out a second feature map corresponding to the face region from the first feature map, and a multi-task parallel detection module configured to process the second feature map through a second backbone network for a follow-up multi-task parallel detection.

In some examples, the first feature map may be produced in a last layer of the first backbone network.

In some examples, the processing the input image through the first backbone network to produce a first feature map of the input image may include performing a convolution and sub-sampling computing process on the input image to produce the first feature map.

In some examples, the detecting a face in the input image may include detecting a face having a highest reliability from a plurality of faces in the input image.

In some examples, the cutting out a second feature map may include cutting out a feature map of a face region corresponding to a face frame from the first feature map of the image using bilinear interpolation.

In some examples, the processing a second feature map through the second backbone network for a follow-up multi-task parallel detection may include extracting features respectively associated with multiple follow-up detection tasks from the second feature map through the second backbone network to input each of the extracted features to each of the multiple branch networks related to the multiple follow-up detection tasks.

In some examples, the multiple branch networks may be trained based on a sum of loss functions of the multiple branch networks.

In some examples, in a case where the multiple branch networks are trained, the first backbone network may be frozen.

In some examples, the multiple follow-up detection tasks may include one or more of key point detection, head posture estimation, and gaze estimation.

In some examples, the first backbone network may be separately trained.

According to the present disclosure, a vehicle includes: a computing device comprising a memory and a processor, the processor configured to: receive an input image, process the input image through a first backbone network to produce a first feature map of the input image, and determining a face region from the input image by detecting a face in the input image; cut out a second feature map corresponding to the face region from the first feature map; and process the second feature map through a second backbone network for a follow-up multi-task parallel detection.

According to examples of the present disclosure, image data features are extracted using a common network model, instead of a serial detection method in the related art, and then parallel multi-tasking is completed using a lightweight network. Through this, multiple tasks of the DMS (for example, face detection, face key point detection, head posture estimation, gaze estimation, and the like) can be combined as a task in a driver's seat. Therefore, several times of pre-processing works (for example, image cutting, size adjustment, normalization, and the like) are not needed to be performed on image data during operation, and thus it is possible to significantly reduce consumption of computing resources (for example, CPU resources). Examples of the present disclosure can realize substantially constant detection accuracy compared to the method in the related art and can reduce an operation time by 50% or more.

Effects of the present disclosure are not limited to the above-mentioned description, and other aspects not mentioned here will be clearly understood by those skilled in the art from the description below.

### BRIEF DESCRIPTION OF THE DRAWINGS

FIG. 1 (RELATED ART) schematically illustrates a conceptual view of a multi-task detection method in the related art.

FIG. 2 schematically illustrates a conceptual view of a multi-task detection method according to an example of the present disclosure.

FIG. 3 schematically illustrates a simplified example of producing a feature map from an input image.

FIG. 4 schematically illustrates an example of a coordinate position mapping.

FIG. 5 is a schematic configuration view of a multi-task detection system according to an example of the present disclosure.

FIG. 6 schematically illustrates a flowchart of a training step of a multi-task detection system according to an example of the present disclosure.

FIG. 7 schematically illustrates a flowchart of an inference step of a multi-task detection system according to an example of the present disclosure.

FIG. 8 is a block diagram schematically illustrating a computing device used in realizing a method or a device according to the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, the present disclosure is described in more detail with reference to drawings, and the drawings illustrate exemplary examples of the present disclosure. Those skilled in the art can recognize that the described exemplary examples can be modified in various ways without departing from a gist or a scope of the present disclosure. Therefore, the drawings and the description should be construed as not being limited but being for explanation. Throughout the specification, like reference numerals represent like elements. In addition, in the following description on some examples, detailed description on known functions and configurations combined thereto are omitted for clarity and conciseness.

Terms including ordinals (for example, first and second) are used to describe various elements, but these elements are not limited by such terms. These terms are used only for distinguishing one element from another element.

As mentioned above, a driver monitoring system frequently needs to perform computing such as face detection, face key point detection, head posture estimation, and gaze estimation. However, in the system in the related art, each module that performs such computing was serial and independent.

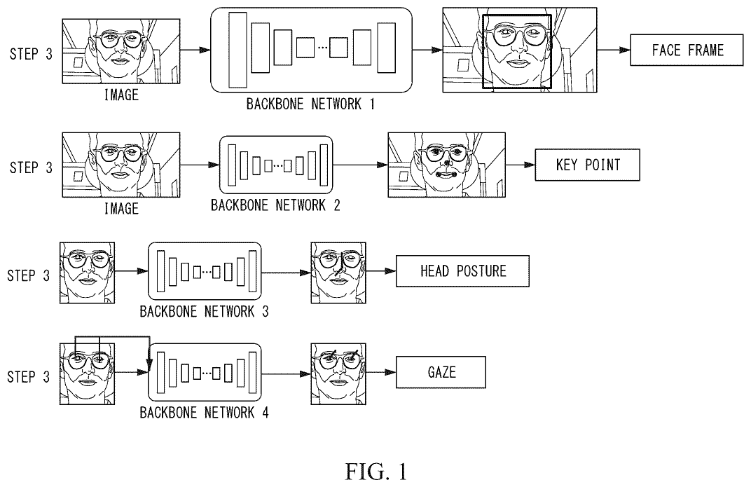

FIG. 1 schematically illustrates a conceptual view of a multi-task detection method in the related art.

As illustrated in FIG. 1, in the multi-task detection method in the related art, each computing is independently performed. Specifically, in step 1, for example, an image including a face captured by a camera (driver's face in present document) is input to a first backbone network. The first backbone network is, for example, MobileNetV1. In addition, the first backbone network may be a convolution neural network (CNN). The first backbone network performs computing on the input image using a general one-stage face detection algorithm such as YOLO and SSD to detect a face, thereby obtaining a face frame.

In step 2, the image is input to a second backbone network. The second backbone network may be, for example, MobileNetV2. In addition, the second backbone network may be CNN. The second backbone network computes the input image to detect a face key point.

In step 3, the face image detected in step 1 is input to a third backbone network. The third backbone network may be, for example, MobileNetV2. In addition, the third backbone network may be CNN. The third backbone network computes the input face image to estimate a driver's head posture.

In step 4, the face image detected in step 1 is input to a fourth backbone network. The fourth backbone network may be, for example, MobileNetV2. In addition, the fourth backbone network may be CNN. The fourth backbone network computes the input face image to estimate a driver's gaze.

Through the above-described detection and estimation, a driver's situation can be monitored.

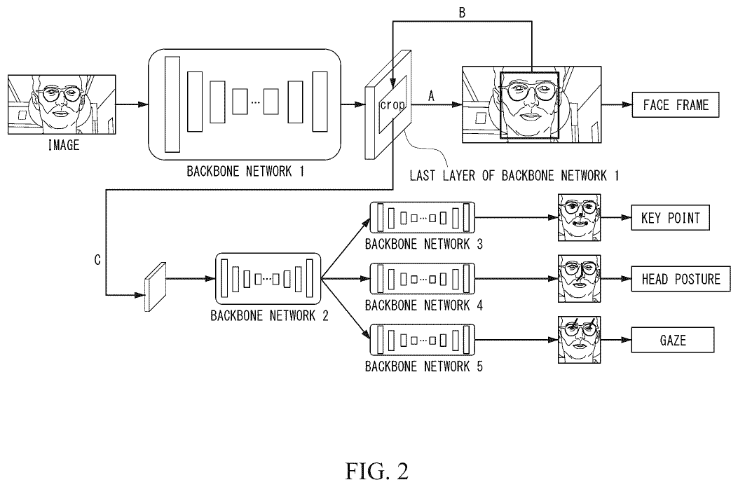

FIG. 2 schematically illustrates a conceptual view of a multi-task detection method according to an example of the present disclosure.

As illustrated in FIG. 2, the multi-task detection method according to an example of the present disclosure, first, inputs an image including a face captured by a camera to a first backbone network, for example. The first backbone network may be, for example, MobileNetV1. In addition, the first backbone network may be a convolution neural network (CNN). The first backbone network can compute the input image using a general one-stage face detection algorithm such as YOLO and SSD to detect a face from the image, thereby obtaining a face frame as indicated by arrow A of FIG. 2.

As understood by those skilled in the art, as a convolution computing is performed on an image in CNN, a feature map is produced. The feature map refers to an output image produced by a convolution layer after performing convolution computing on the input image (or output of preceding layer) in CNN, and this refers to a feature extracted from the input image after the convolution computing. A convolution kernel (also referred to as filter) in CNN slides on the input image (or feature map of preceding layer) to perform convolution computing. After that, a bias term is added and a feature map is produced using an activation function (for example, ReLU).

In general, the feature map is a three-dimensional map consisting of height, width, and channel. The height and the width indicate a spatial magnitude of the feature map, whereas a number of channels corresponds to a number of used convolution kernels, and each kernel produces a corresponding feature map. Feature maps of different layers capture different abstraction-level features. A relatively low stratum tends to capture a detailed feature such as edge and texture, whereas a high stratum captures more semantic information.

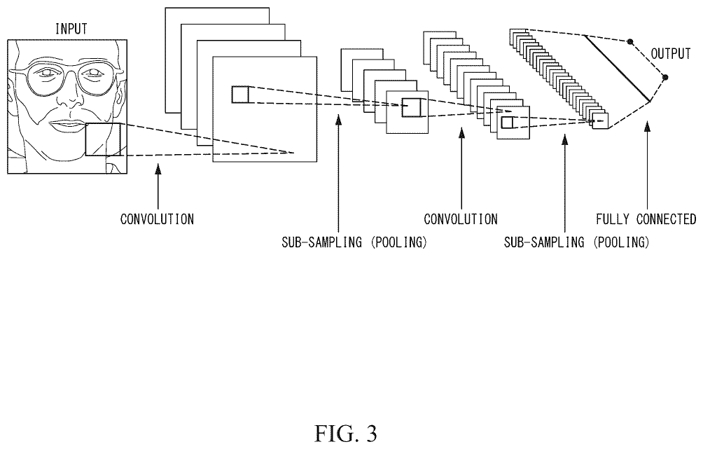

FIG. 3 schematically illustrates a simplified example of producing a feature map from an input image.

As illustrated in FIG. 3, convolution computing is performed on the input image to extract information from the image. Subsequently, through the sub-sampling (pooling) computing, dimensions of the feature map output from the preceding layer are reduced and a calculation amount is reduced to prevent overfitting. Several times of convolutions and sub-sampling computing are alternately performed on the input image, and then information of all feature maps are integrated by a complete connection layer to obtain a final output result.

With reference to FIG. 2 again, subsequently, a coordinate position of a face frame in the image is remapped to a feature map (specifically, feature map produced from last layer of first backbone network) produced in the first backbone network, and as indicated by arrow B of FIG. 2, a feature map of a face region of interest (ROI) corresponding to the face frame is cut out from the feature map.

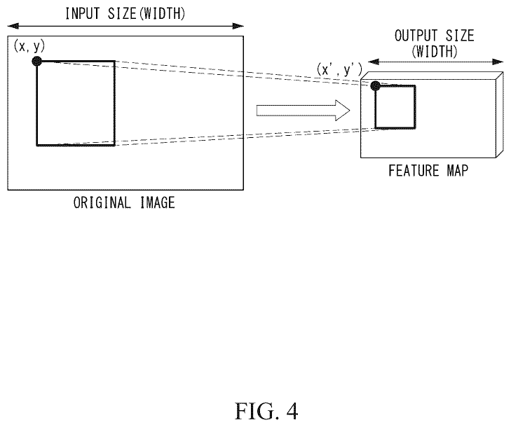

FIG. 4 schematically illustrates an example of a coordinate position mapping.

As illustrated in FIG. 4, a magnitude of the original image can be referred to as an input magnitude, and a magnitude of the feature map produced in the original image can be referred to as an output magnitude. Then, there is a following relation between the output magnitude and the input magnitude.

Output magnitude=(input magnitude−kernel magnitude+2×padding)/stride+1

Here, “kernel magnitude”, “padding”, and “stride” refer to kernel magnitude, padding, and stride used for performing convolution computing in the original image, respectively. As an example, the kernel magnitude may be 3×3, padding may be 1, and stride may be 2.

Therefore, a coordinate position (x, y) of the face frame in the original image can be mapped to a feature map produced from the original image according to the following formula, thereby obtaining a corresponding coordinate position (x′, y′) of the face frame in the feature map.

x′=x/(input magnitude/output magnitude)

y′=y/(input magnitude/output magnitude)

With reference to FIG. 2 again, at this time, a feature map of a face region of interest (ROI) corresponding to the face is cut out from the feature map based on the corresponding coordinate position (x′, y′) of the face frame in the feature map (indicated by arrow C of FIG. 2).

Subsequently, the feature map of the face ROI is input to the second backbone network. The second backbone network extracts features related to a follow-up multi-task detection from the feature map of the face ROI, and these features are distributed in one or more of follow-up backbone networks (also referred as branch networks in present document) such as third backbone network, fourth backbone network, and fifth backbone network to further perform other detection tasks such as key point detection, head posture estimation, and gaze estimation.

The method of the present disclosure is input to the second backbone network unlike the detection method in the related art, and thus data input to the third backbone network, the fourth backbone network, and the fifth backbone network is a feature map of a face ROI cut out from the feature map of the original image obtained in the first backbone network. In other words, only the first backbone network performs primary inference on the original image, the obtained inference result (that is, feature map) is reused for multiple detection tasks (face detection, key point detection, head posture detection, gaze detection, and the like). As outputs of the first backbone network are shared in different tasks, redundant computing (for example, computing at time of producing feature map (for example, convolution computing)) can be reduced, efficiency is improved.

Moreover, since a data amount of the feature map of the face ROI is far less than that of the original image, the second backbone network, the third backbone network, the fourth backbone network, and the fifth backbone network can adopt a lightweight backbone network such as simplified version of MobileNetV2 (for example, neural network of about 3 to 5 layers). Those skilled in the art will understand that a lightweight backbone network also referred to as a micro neural network is characterized by small parameters and low computing costs, and thus is suitable to be distributed in a device with limited computing resources such as smartphone, tablet, and other embedded devices.

Table 1 below compares an algorithm magnitude at a time of realizing multi-task detection through a method in the related art with an algorithm magnitude at a time of realizing multi-task detection through a method according to an example of the present disclosure.

TABLE 1

| | | Method of |
|---|---|---|
| | Method in the | the present |
| | related art | disclosure |
| Face (frame) detection | 5.1M | 5.1M |
| Gaze estimation | 3.4M | 0.35M |
| Head posture estimation | 3.4M | 0.21M |
| Key point detection | 3.6M | 0.23M |
| Sum | 15.5M | 5.89M |

As can be seen from Table 1, an inference result of the first backbone network is reused at a time of performing the follow-up detection tasks (for example, gaze estimation, head posture estimation, key point detection), and thus the follow-up network can adopt a very few numbers of parameters, and with this, the magnitude of the algorithm is significantly reduced and efficiency is improved.

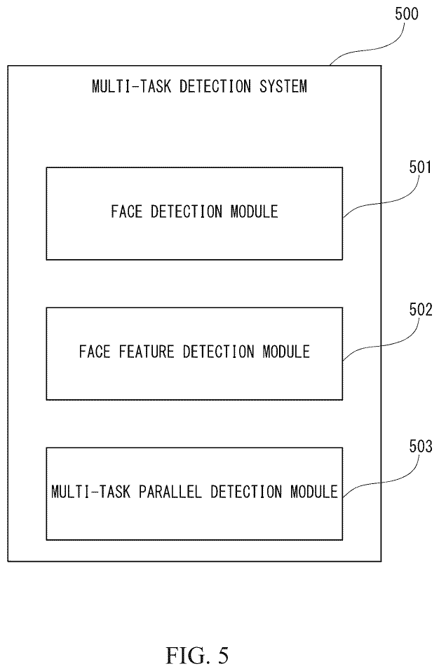

FIG. 5 is a schematic configuration view of a multi-task detection system according to an example of the present disclosure.

As illustrated in FIG. 5, a multi-task detection system (500) may include a face detection module (501), a face feature extraction module (502), and a multi-task parallel detection module (503).

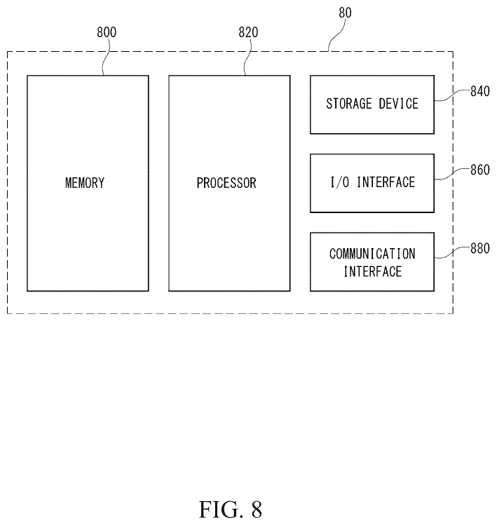

Each of the above modules (501, 502, and 503) may constitute modules and/or devices of the multi-task detection system (500), which may be carried out by a computing device 80 (see FIG. 8, as described herein)—which incorporates one or more processors and/or controllers. For example, the above modules of the multi-task detection system (500) may constitute hardware components that form part of a controller (e.g., modules or devices of a high-level controller), or may constitute individual controllers each having a processor and memory. The multi-task detection system (500) may include one or more processors and memory.

The face detection module (501) receives an input image, processes the input image through the first backbone network to produce a feature map of the image, and detects a face from the image. In some examples, the first backbone network may be a convolution neural network (CNN). In these examples, processing the input image may include performing convolution and sub-sampling computing on an image to produce a feature map. In some examples, the feature map of the image may be a feature map produced in a last layer of the first backbone network.

In addition, in some examples, in a case where multiple faces are present in the image, a face with highest reliability (driver's face in context of present document) can be detected from the image.

In addition, in some examples, the first backbone network can be trained alone.

The face feature extraction module (502) remaps a face frame coordinate related to a face from the input image data to the produced feature map to cut out a feature map of a face region corresponding to the face frame. In some examples, the feature map of the face region corresponding to the face frame can be cut out from the feature map of the image using bilinear interpolation.

The multi-task parallel detection module (503) receives the feature map of the cut face region, processes thereof through the second backbone network for use in the follow-up multi-task parallel detection. In some examples, each of features related to the multiple follow-up detection tasks can be extracted from the feature map of the face region through the second backbone network and can be input to each of multiple branch networks related to the multiple follow-up detection tasks.

In some examples, multiple branch networks can be trained based on a sum of loss functions of the multiple branch networks.

In some examples, at a time of training multiple branch networks, the first backbone network can be frozen, and with this, it is possible for training of the multiple branch networks not to affect the first backbone network.

In some examples, the multiple detection tasks may include one or more of key point detection, head posture estimation, and gaze estimation.

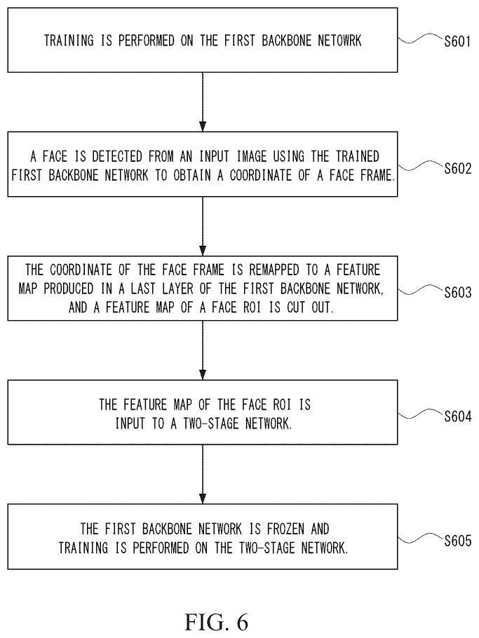

FIG. 6 schematically illustrates a flowchart of training steps of a multi-task detection system according to an example of the present disclosure.

As illustrated in FIG. 6, in S601, training is performed on the first backbone network. As mentioned above, the first backbone network is used to detect a face from an input image. In training, training of detecting a face can be performed.

In S602, a face is detected from the input image using the trained first backbone network to obtain a coordinate of a face frame.

In S603, the coordinate of the face frame is remapped to a feature map produced in a last layer of the first backbone network, and a feature map of a face ROI is cut out. In some examples, cutting out (i.e., extracting) the feature map of the face ROI can be realized using bilinear interpolation.

In S604, the feature map of the face ROI is input to a two-stage network. In some examples, the two-stage network includes a second backbone network and multiple parallel branch networks (for multi-task detection).

In S605, the first backbone network is frozen and training is performed on the two-stage network. In some examples, during a training period, training is performed on the two-stage network based on a sum of loss functions of the multiple branch networks.

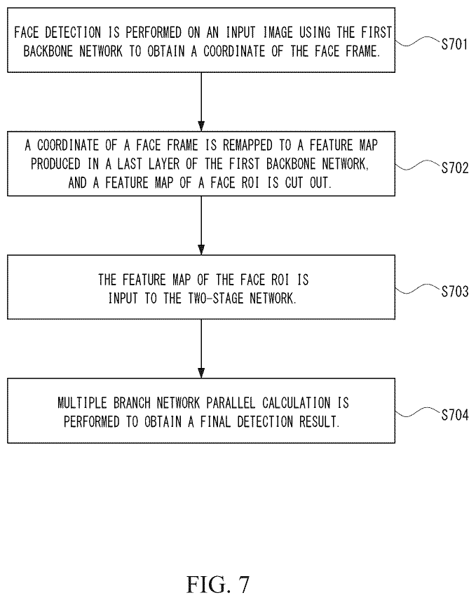

FIG. 7 schematically illustrates a flowchart of inference steps of a multi-task detection system according to an example of the present disclosure.

As illustrated in FIG. 7, in S701, face detection is performed on an input image using the first backbone network to obtain a coordinate of the face frame. In some examples, in a case where multiple faces are present in the image, a face with highest reliability (driver's face in present document) can be detected from the image.

In S702, a coordinate of a face frame is remapped to a feature map produced in a last layer of the first backbone network, and a feature map of a face ROI is cut out. In some examples, cutting of the feature map of the face ROI can be realized using bilinear interpolation.

In S703, the feature map of the face ROI is input to the two-stage network. In some examples, the two-stage network includes the second backbone network and multiple parallel branch networks (for multi-task detection).

In S704, multiple branch network parallel calculation is performed to obtain a final detection result. In some examples, the final detection result may be, for example, head posture, face key point, gaze vector, and the like.

Table 2 below compares accuracy at a time of performing multi-task detection using a method in the related art with accuracy at a time of performing multi-task detection using a method according to an example of the present disclosure. In the test, 232,112 images were used as training data, 23,734 images were used as test data, and the resolution is 1,920×1,080.

TABLE 2

| | | Method of | |
|---|---|---|---|
| | Method in the | the present | |
| | related art | disclosure | Description |
| Face frame | 99.87% | 99.83% | AP: Average precision is a |
| (AP50) | | | value that summarizes a |
| | | | precision-reproducibility |
| | | | curve (P-R curve) as a |
| | | | weighted average of |
| | | | precision achieved at each |
| | | | threshold and uses an |
| | | | increase in reproducibility |
| | | | after the previous threshold |
| | | | as a weighted value (the |
| | | | higher the number, the |
| | | | higher the precision). |
| Gaze | 4.72 | 4.83 | MAE: Average absolute |
| (MAE Euler | | | error, average of absolute |
| angle) | | | difference between |
| | | | prediction value and actual |
| | | | value (the lower the number, |
| | | | the higher the precision). |
| Head posture | 3.289 | 3.332 | MAE: Average absolute |
| (MAE Euler | | | error, average of absolute |
| angle) | | | difference between |
| | | | prediction value and actual |
| | | | value (the lower the number, |
| | | | the higher the precision). |
| Key point | 3.82 | 3.91 | IPN: For interpupillary |
| (IPN) | | | distance normalization, |
| | | | test data is adjusted or |
| | | | standardized based on |
| | | | individual interpupillary |
| | | | distance (the lower the |
| | | | number, the higher the |
| | | | precision). |

Table 3 below compares an inference time at a time of performing multi-task detection using a method in the related art with an inference time at a time of performing multi-task detection using a method according to an example of the present disclosure. In the test, 232,112 images were used as training data, 23,734 images were used as test data, and the resolution is 1,920×1,080.

TABLE 3

| | |
|---|---|
| | Method of |
| Method in the | the present |
| related art | disclosure |

| | | | | |
|---|---|---|---|---|
| GPU | 7.7 | ms | 2.7 | ms |
| CPU | 25.6 | ms | 12.4 | ms |
| Kirin 9000 | 75.5 | ms | 38.1 | ms |
| Qualcomm Snapdragon | 58.6 | ms | 28.2 | ms |
| 8 + Gen 1 | | | | |

As can be seen from Tables 2 and 3, in comparison with the methods in the related art, the method according to an example of the present disclosure can basically achieve constant accuracy and reduce an operation time by 50% or more at the same time by extracting image features by reusing a common network, and by realizing multi-task detection by using a lightweight branch network, and with this, can significantly reduce consumption of computing resources (for example, CPU, GPU, NPU, DSP, and the like).

Although four operations of face detection, face key point detection, head posture estimation, and gaze estimation are described above, this is only to describe examples of the present disclosure and does not limit the technical idea of the present disclosure. In other examples, more or less computing may be included, and other different computing may be present or the computing may be substituted with other different computing.

Hereinabove, examples of the present disclosure are described based on face detection, but the present disclosure is not limited thereto, and it should be understood that the technical idea of the present disclosure may be applied to detect other targets in an image from other scenarios.

FIG. 8 is a block diagram schematically illustrating a computing device used in realizing a method or a device according to the present disclosure.

A computing device (80) may include some or all of a memory (800), a processor (820), a storage device (840), an input/output (I/O) interface (860), or a communication interface (880). The computing device (80) may include at least some of a face detection module (501), a face feature extraction module (502), and a multi-task parallel detection module (503) in terms of structure and/or function. The computing device (80) may be a fixed computing device such as desktop computer, server, and AI accelerator, or may be a portable computing device such as notebook computer and smartphone.

The memory (800) may store a program that causes the processor (820) to perform a method or an operation according to various examples of the present disclosure. For example, the program may include multiple commands that can be executed by the processor (820), and in a case where the processor (820) executes multiple commands, the method illustrated in FIG. 6 or 7 can be performed.

The memory (800) may be a single memory or multiple memories. In this case, information necessary for performing a method or an operation according to various examples of the present disclosure may be stored in a single memory, or may be stored in multiple memories in a distributed way. In a case where the memory (800) includes multiple memories, the multiple memories can be physically separated.

The memory (800) may include at least one of volatile memory or non-volatile memory. The volatile memory includes a static random access memory (SRAM) or a dynamic random access memory (DRAM), and the non-volatile memory includes a flash memory.

The processor (820) may include at least one core to execute at least one command. The processor (820) can execute commands stored in the memory (800). The processor (820) may be a single processor or multiple processors.

The storage device (840) stores data stored even in a case where a power supplied to the computing device (80) is shut off. For example, the storage device (840) may include a storage medium such as non-volatile memory and/or tape, and optical disk or magnetic disk.

The program stored in the storage device (840) may be loaded in the memory (800) before being executed by the processor (820). The storage device (840) can store a file made by using a program language, and causes a program produced from the file by a compiler and the like to be loaded in the memory (800). The storage device (840) can store data to be processed by the processor (820) and/or data processed by the processor (820).

The I/O interface (860) may include an input device such as keyboard and mouse, and may include an output device such as display device and printer. The user can trigger the processor (820) through the I/O interface to execute a program and/or examine a processing result from the processor (820).

The communication interface (880) can provide access to an external network. For example, the computing device (80) can communicate with other devices (for example, face detection module (501), face feature extraction module (502), or multi-task parallel detection module (503)) through the communication interface (880).

Each member of the device or method according to the present disclosure can be realized as hardware or software, or can be realized as a combination of hardware and software. In addition, functions of each member can be realized as software, and the microprocessor can be realized to execute functions of software corresponding to each member.

Various examples of the systems and technologies described in the present document can be realized as a digital electronic circuit, an integrated circuit, a field programmable gate array (FPGA), an application specific integrated circuit (ASIC), computer hardware, firmware, software and/or a combination thereof. Various examples may include a realization method including one or more computer programs that can be executed in a programmable system. The programmable system includes at least one programmable processor, may include an application specific processor or a general use processor, and these are combined to receive data and commands from a storage system, at least one input device, and at least one output device, and transmit data and commands. The computer program (program, software, software application or code) includes commands used for the programmable processor, and is stored in a computer-readable storage medium.

The computer-readable storage medium may include all kinds of storage devices that can store computer-readable data. The computer-readable storage medium may be a non-volatile non-transitory medium such as read only memory (ROM), random access memory (RAM), compact disk ROM (CD-ROM), magnetic tape, floppy disk, and optical data storage device. In addition, the computer-readable storage medium may include a transitory medium such as data transmission medium. In addition, the computer-readable storage medium may be distributed in computer systems connected through a network, and the computer-readable program code can be realized by being stored in a distributed method.

Operations shown in flowcharts/timing diagrams of the present disclosure are sequentially performed, but this is merely an explanation on the technical idea of an example of the present disclosure. In other words, those skilled in the art will understand that the present disclosure can be variously modified and changed without departing from the gist of the present disclosure. That is, the order shown in the flowcharts/timing diagrams can be modified, and one or more operations can be performed in parallel. Therefore, the flowcharts/timing diagrams are not limited to the time sequence.

Examples of the present disclosure have been described for explanation, but those skilled in the art will understand that various modifications, additions, and substitutions can be made without departing from the scope and the gist of the present disclosure. Therefore, examples of the present disclosure have been described for conciseness and clarity. The scope of the technical idea of the present examples are not limited to such explanation. Therefore, those skilled in the art should understand that the scope of the present disclosure should not be limited to the examples clearly described above, and should be limited only by claims and the equivalents.

What is claimed is:

1. A multi-task detection method comprising:
providing a processor and a memory;
receiving, by the processor, an input image;
processing, by the processor, the input image through a first backbone network to produce a first feature map of the input image, and determining, by the processor, a face region from the input image by detecting a face in the input image;
extracting, by the processor, a second feature map corresponding to the face region from the first feature map; and
inputting, by the processor, the second feature map to a second backbone network for a follow-up multi-task parallel detection.

2. The method according to claim 1, wherein the first feature map is produced in a last layer of the first backbone network.

3. The method according to claim 1, wherein processing the input image through the first backbone network to produce the first feature map of the input image includes performing a convolution and sub-sampling computing process on the input image to produce the first feature map.

4. The method according to claim 1, wherein detecting the face in the input image includes detecting a face having a highest reliability from a plurality of faces in the input image.

5. The method according to claim 1, wherein extracting the second feature map includes extracting a face region corresponding to a face frame from the first feature map using bilinear interpolation.

6. The method according to claim 1, wherein inputting the second feature map to the second backbone network includes extracting features respectively associated with multiple follow-up detection tasks from the second feature map through the second backbone network to input each of the extracted features to each of multiple branch networks related to the multiple follow-up detection tasks.

7. The method according to claim 6, further comprising:
training, by the controller, the multiple branch networks based on a sum of loss functions of the multiple branch networks.

8. The method according to claim 7, wherein, in a case where the multiple branch networks are trained, the first backbone network is frozen.

9. The method according to claim 6, wherein the multiple follow-up detection tasks include one or more of key point detection, head posture estimation, or gaze estimation.

10. The method according to claim 1, wherein the first backbone network is separately trained.

11. A multi-task detection system comprising:
a computing device comprising a memory and a processor, the processor configured to:
receive an input image, process the input image through a first backbone network to produce a first feature map of the input image, and determining a face region from the input image by detecting a face in the input image;
cut out a second feature map corresponding to the face region from the first feature map; and
process the second feature map through a second backbone network for a follow-up multi-task parallel detection.

12. The system according to claim 11, wherein the first feature map is produced in a last layer of the first backbone network.

13. The system according to claim 11, wherein processing the input image through the first backbone network includes performing a convolution and sub-sampling computing process on the input image to produce the first feature map.

14. The system according to claim 11, wherein detecting the face in the input image includes detecting a face having a highest reliability from a plurality of faces in the input image.

15. The system according to claim 11, wherein extracting the second feature map includes extracting a feature map of a face region corresponding to a face frame from the first feature map of the image using bilinear interpolation.

16. The system according to claim 11, wherein the processing the second feature map through the second backbone network includes extracting features respectively associated with multiple follow-up detection tasks from the second feature map through the second backbone network to input each of the extracted features to each of the multiple branch networks related to the multiple follow-up detection tasks.

17. The system according to claim 16, wherein the multiple branch networks are trained based on a sum of loss functions of the multiple branch networks.

18. The system according to claim 17, wherein, in a case where the multiple branch networks are trained, the first backbone network is frozen.

19. The system according to claim 16, wherein the multiple follow-up detection tasks include one or more of key point detection, head posture estimation, or gaze estimation.

20. A vehicle comprising:
a computing device comprising a memory and a processor, the processor configured to:
receive an input image, process the input image through a first backbone network to produce a first feature map of the input image, and determining a face region from the input image by detecting a face in the input image;
cut out a second feature map corresponding to the face region from the first feature map; and
process the second feature map through a second backbone network for a follow-up multi-task parallel detection.
